(19) United States
(12) Patent Application Publication
(10) Pub. No.: US 2024/0202735 A1
(43) Pub. Date: Jun. 20, 2024

(54) METHOD AND SYSTEM FOR PROVIDING A DYNAMIC UNIFIED PAYMENT INTERFACE

(71) Applicant: JPMorgan Chase Bank, N.A., New York, NY (US)

(72) Inventor: Pavan KADIYALA, Hyderabad (IN)

(73) Assignee: JPMorgan Chase Bank, N.A., New York, NY (US)

(21) Appl. No.: 18/108,892

(22) Filed: Feb. 13, 2023

(30) Foreign Application Priority Data
Dec. 16, 2022 (IN) 202211072982

(51) Int. Cl. G06Q 20/40; G06Q 20/10; G06Q 20/38

(52) U.S. Cl. CPC G06Q 20/405; G06Q 20/108; G06Q 20/389

(57) ABSTRACT

A method for providing a dynamic Unified Payment Interface (UPI) to a user is disclosed. The method includes: receiving an input of the user associated with selection of at least one UPI mode from a plurality of UPI modes. Next, the method includes analyzing the UPI mode(s) selected by the user for a processing of a payment. Thereafter, the method includes performing the payment based on the selection and analysis of the UPI mode(s) selected by the user. The plurality of UPI modes includes a basic UPI mode, a custom UPI mode and an Artificial Intelligence (AI) based UPI mode.

### CROSS-REFERENCE TO RELATED APPLICATIONS

This application claims priority benefit from Indian Application No. 202211072982, filed Dec. 16, 2022 in the Indian Patent Office, which is hereby incorporated by reference in its entirety.

### FIELD OF THE DISCLOSURE

This technology generally relates to an electronic payment system. More particularly, the present disclosure relates to a method and system for providing a dynamic Unified Payment Interface (UPI) based on the requirement of the user.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

Digital payments have received a boost in the last few years almost in every sector whether it is for business, education, or entertainment purposes as well as even for helping or supporting each other in hard times. With the advent of the Unified Payment Interface (UPI) platforms, financial transactions have increased from a common individual to a corporate entity. UPI is a system that allows the connectivity of multiple participating bank accounts into a single mobile application for performing all kinds of financial transactions.

However, with an increase in the number of accounts, users are facing several problems in choosing an appropriate account for the payment. It is also known that many of the time, the payment or transaction from a default account get interrupted due to various factors such as internet issue, balance issue, server issue and the like. For example, a user configured multiple UPI accounts for UPI application, and one is set as a default account. All the transactions then executed from the default account. If default bank servers cannot be reached, the user needs to initiate the transaction again using another UPI account which resulted from multiple manual steps. The pain points of the existing UPI applications are the static nature of digital payment process that relies on default settings and involves multiple manual steps for performing a transaction in one or more conditions like insufficient balance in default account.

Hence, in view of these and other existing limitations, there arises an imperative need to provide an efficient solution to overcome the above-mentioned limitations and to provide a method and system for optimizing and providing a dynamic Unified Payment Interface for users based on conditions associated with the transaction.

### SUMMARY

The present disclosure, through one or more of its various aspects, embodiments, and/or specific features or sub-components, provides, inter alia, various systems, servers, devices, methods, media, programs, and platforms for providing a dynamic Unified Payment Interface (UPI) for users.

According to an aspect of the present disclosure, a method for providing a dynamic Unified Payment Interface (UPI) is disclosed. The method is implemented by a processor. The method includes receiving, at the processor, an input of a user associated with a selection by the user of at least one UPI mode from a plurality of UPI modes. Next, the method includes analyzing, by the processor, the at least one UPI mode selected by the user for a processing of a payment. Thereafter, the method includes performing, by the processor, the payment based on the selection and analysis of the at least one UPI mode. The plurality of UPI modes comprises a basic UPI mode, a custom UPI mode and an Artificial Intelligence (AI) based UPI mode.

In accordance with an exemplary embodiment, when the basic UPI mode is selected, the method may further include the steps of receiving, at the processor, an input of the user associated with a selection by the user of at least one default rule from a plurality of default rules: and performing, by the processor, the payment based on the default rule selected by the user.

In accordance with an exemplary embodiment, when the custom UPI mode is selected, the method may further include the steps of receiving, at the processor, an input of the user associated with a creation by the user of at least one custom rule that satisfies a requirement of the user: and performing, by the processor, the payment based on the at least one custom rule created by the user.

In accordance with an exemplary embodiment, when the Artificial Intelligence (AI) based UPI mode is selected, the method may further include the steps of receiving, at the processor, a set of data associated with payments previously made by the user; analyzing, by the processor using a trained model, the set of data for a recommendation of at least one optimized payment mode: and recommending, by the processor, the at least one optimized payment mode for the processing of the payment.

In accordance with an exemplary embodiment, the set of data may include user transaction history, bank stability history, user preference mode of transaction, user defined configuration rules, current bank server health, current bank server stability and connectivity, and user preferences with respect to balance availability.

In accordance with an exemplary embodiment, when the Artificial Intelligence based UPI mode is selected, the method may further include recommending, by the processor, at least one action to be performed based on a transactions history of the user.

According to another aspect of the present disclosure, a computing device configured to implement an execution of a method for providing a dynamic Unified Payment Interface (UPI) is disclosed. The computing device includes a processor: a memory: and a communication interface coupled to each of the processor and the memory. The processor is configured to: receive, via the communication interface, an input of the user associated with a selection by the user of at least one UPI mode from a plurality of UPI modes; analyze the at least one UPI mode selected by the user for a processing of a payment: and execute or perform the payment based on the selection and analysis of the at least one UPI mode selected by the user. The plurality of UPI modes comprises a basic UPI mode, a custom UPI mode and an Artificial Intelligence-based UPI mode.

In accordance with an exemplary embodiment, when the basic UPI mode is selected, the processor may be further configured to: receive, via the communication interface, an input of the user associated with a selection by the user of at least one default rule from a plurality of default rules: and perform the payment based on the default rule selected by the user.

In accordance with an exemplary embodiment, when the custom UPI mode is selected, the processor may be further configured to: receive, via the communication interface, an input of the user associated with a creation by the user of at least one custom rule that satisfies a requirement of the user; and perform the payment based on the at least one custom rule created by the user.

In accordance with an exemplary embodiment, when the Artificial Intelligence (AI) based UPI mode is selected, the processor may be further configured to: receive, via the communication interface, a set of data associated with payments previously made by the user: analyze, using a trained model, the set of data for a recommendation of at least one optimized payment mode; and recommend the at least one optimized payment mode for the processing of the payment.

In accordance with an exemplary embodiment, the set of data may include user transaction history, bank stability history, user preference mode of transaction, user defined configuration rules, current bank server health, current bank server stability and connectivity, and user preferences with respect to balance availability.

In accordance with an exemplary embodiment, when the Artificial Intelligence based UPI mode is selected, the processor may be further configured to recommend at least one action to be performed based on a transactions history of the user.

According to yet another aspect of the present disclosure, a non-transitory computer readable storage medium storing instructions for providing a dynamic Unified Payment Interface (UPI) is disclosed. The instructions include executable code which, when executed by a processor, may cause the processor to: receive an input of the user associated with a selection by the user of at least one UPI mode from a plurality of UPI modes: analyze the at least one UPI mode selected by the user for a processing of a payment: and perform the payment based on the selection and analysis of the at least one UPI mode selected by the user. The plurality of UPI modes comprises a basic UPI mode, a custom UPI mode and an Artificial Intelligence based UPI mode.

In accordance with an exemplary embodiment, when the basic UPI mode is selected, the executable code may further cause the processor to: receive an input of the user associated with a selection by the user of at least one default rule from a plurality of default rules; and perform the payment based on the default rule selected by the user.

In accordance with an exemplary embodiment, when the custom UPI mode is selected, the executable code may further cause the processor to: receive an input of the user associated with a creation by the user of at least one custom rule that satisfies a requirement of the user: and perform the payment based on the at least one custom rule created by the user.

In accordance with an exemplary embodiment, when the Artificial Intelligence (AI) based mode is selected, the executable code may further cause the processor to: receive a set of data associated with payments previously made by the user: analyze, using a trained model, the set of data for a recommendation of at least one optimized payment mode: and recommend the at least one optimized payment mode for the processing of the payment.

In accordance with an exemplary embodiment, the set of data may include user transaction history, bank stability history, user preference mode of transaction, user defined configuration rules, current bank server health, current bank server stability and connectivity, and user preferences with respect to balance availability.

In accordance with an exemplary embodiment, when the Artificial Intelligence based UPI mode is selected, the processor may be further configured to recommend at least one action to be performed based on a transactions history of the user.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a dynamic Unified Payment Interface (UPI), in accordance with an embodiment of the present disclosure.

FIG. 4 illustrates an exemplary method flow diagram related to a dynamic Unified Payment Interface (UPI), in accordance with an embodiment of the present disclosure.

FIG. 5 illustrates an exemplary sequence diagram related to a basic mode of a Unified Payment Interface (UPI), in accordance with an embodiment of the present disclosure.

FIG. 6 illustrates an exemplary sequence diagram related to a custom mode of a Unified Payment Interface (UPI), in accordance with an embodiment of the present disclosure.

FIG. 7 illustrates an exemplary sequence diagram related to an Artificial Intelligence (AI) mode of a Unified Payment Interface (UPI), in accordance with an embodiment of the present disclosure.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections: the actual physical connections may be different.

In addition, all logical units/controller described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent however, that the disclosure may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the problems associated with static Unified Payment Interface (UPI) and selection of appropriate account for the payment, the present disclosure provides an efficient solution for UPI payment. UPI transactions include multiple steps to perform till the successful execution of the payment which may also include switching from one account to another account for payment in an event the payment fails from the default account. In an example, user A has configured multiple UPI accounts for UPI transactions and one account is set as a default account, where all the transactions will be executed. If the default bank servers cannot be reached, the user has to initiate the transaction again using another UPI account which will result in the use of multiple steps and extensive amount of time of the user. Thus, to solve above-mentioned problem, the present disclosure provides an efficient and reliable dynamic Unified Payment Interface (UPI) where the user may choose at least one mode from a plurality of UPI modes as per the requirement and the payment can be done using the selected mode. In an embodiment, the present invention provides a smart Unified Payment Interface application for the ease of payment process for the user. Thus, the present invention allows the users to configure multiple UPI identifications (IDs) for transactions and takes the decision of using the appropriate UPI ID dynamically by considering multiple parameters. The present invention provides a plurality of UPI modes to the user to ease the task of the user of performing UPI payments in various conditions. The plurality of modes includes but is not limited to a basic UPI mode (also referred to herein as “Basic mode”), a custom UPI mode (also referred to herein as “Custom mode”), and an Artificial Intelligence (AI) based UPI mode.

The Basic mode is defined as the mode comprising of a set of default rules so that users can use any of the rule defined by the system for the basic operations. For example, one of the default rules can be “minimum balance rule” or “choose a stable account” rules either maintaining a minimum balance for the specified accounts or identifying a stable account which works well even in a remote area. In Basic mode, some ground rules or default values need to be provided by the system for making users comfortable while doing payments without getting into the complex modification and technical understanding. The UPI application in this Basic mode executes some basic rules such as “Choose stable account”, the application will always maintain bank server's health by a scheduler, on the basis of this rule and then the UPI account will be selected depending on the stable network at that point of time.

The second mode corresponds to the Custom UPI mode. In this mode, users can also create new custom rules based on various requirements. In an example, a user can specify that the first 15 days of the month use the “xyz” bank account for the transaction and the remaining days will have to use the “abc” bank account. The user has customized this rule which will be processed during the transaction request call by the processor. Here the user has set rules for scheduling its two bank accounts alternately within 15 days. The present invention provides an opportunity for the user to dynamically enable or disable the rules and making these rules as their Custom mode based on the requirement.

The third mode corresponds to the Artificial Intelligence (AI) based UPI mode. In an embodiment, the AI based UPI mode uses a server-side trained module to analyze all of the previous transactions and suggests a best and optimized UPI account for the future transactions. The AI based UPI mode does all the learning from the user transactions applied. The trained model considers various factors while recommending UPI payment options. The factors include but are not limited to user preferences and configured rules, bank server health and connectivity, bank server stability, balance availability, geographical parameters, transaction history, and success rate of past transactions. The AI based UPI mode basically performs certain steps such as analysis of user's data transactions, frequencies of bank account activated for different transactions, priorities of transactions falling at due date etc., in order to achieve the best analysis and recommendation for the user while doing any payment. In an embodiment, the AI module analyzes the previous transaction history and current stability of bank servers to recommend the best mode of action for the UPI payment. In an example, the user has a rule on Bank A i.e., EMI 20k on 1^{st} of every month. However, the Bank A has 20k only and Bank B servers are not stable. The AI based recommendation for this transaction will happen from Bank A and post transaction the action can be recommended to “transfer back same amount from Bank B to Bank A as soon as Bank B is healthy”.

In an example, a user B multiple bank accounts X, Y, Z from multiple banks and the user B is engaged in performing numerous digital payments. While executing digital payment for an event like festival entry, the user B has to perform manual steps for configuring bank account details and setting one of the accounts as default. For instance, the default bank account is Y for the user B. Sometimes it might be possible that during the processing of the payment, the default bank fails to connect with the server for the payment. The user B is also not aware of the fact that the bank account Y needs to have some minimum bank balance for doing any transactions. Despite all these issues, user B tries to perform a UPI based transaction using account Y and fails to perform the required payment. The failure of the transaction may affect the user in booking the tickets of the event for which the user was trying to attend. However, the AI based UPI mode of the present invention will help the user in increasing the chances of successful payments in one or two attempts only. The AI based UPI mode recommends the best option for payment to the user considering the bank server connectivity, bank availability, geographical parameters, transaction history, bank server health, balance availability, user preferences and not limited thereto. Thus, the present disclosure provides an efficient solution for the payment using a dynamic Unified Payment Interface (UPI).

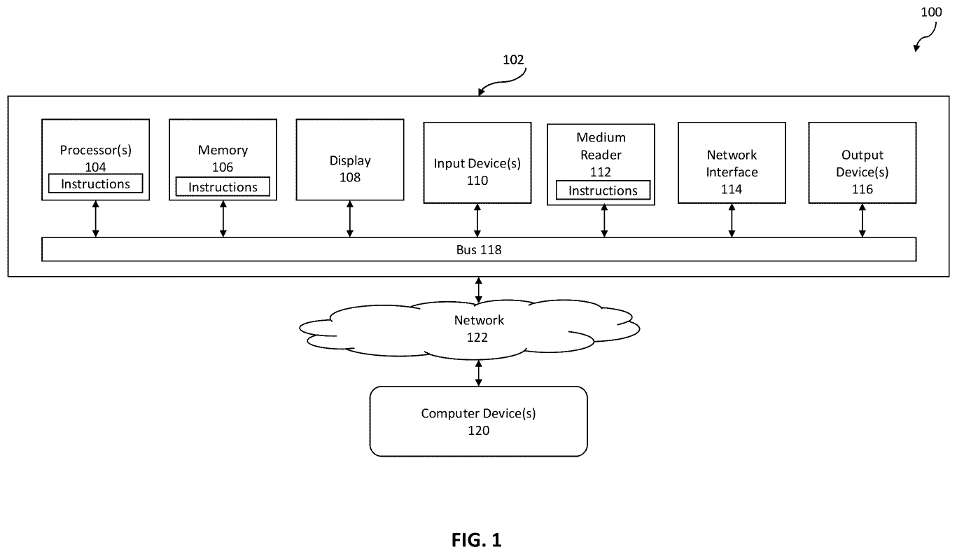

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As used herein, a Unified Payment Interface (UPI) is a real-time payment system where multiple bank accounts are merged into single mobile application for transferring money between at least two bank accounts.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present invention, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide an optimized methods and systems for the dynamic Unified Payment Interface (UPI) applications.

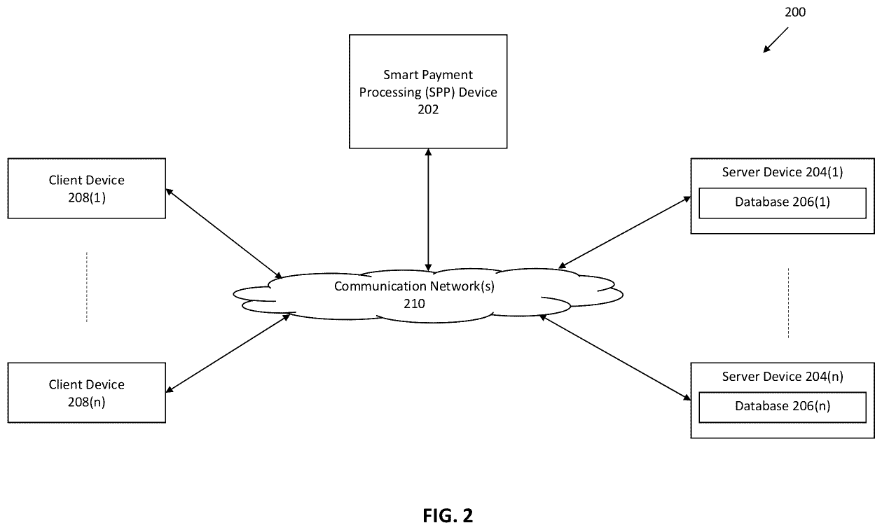

Referring to FIG. 2, a schematic of an exemplary network environment 200 for implementing a method for optimizing dynamic Unified Payment Interface (UPI) applications is illustrated. In an exemplary embodiment, the method is executable on any networked computer platform, such as, for example, a personal computer (PC).

The method for providing a dynamic Unified Payment Interface (UPI) is implemented by a Smart Payment Processing (SPP) device 202. The SPP device 202 may be the same or similar to the computer system 102 as described with respect to FIG. 1. The SPP device 202 may store one or more applications that can include executable instructions that, when executed by the SPP device 202, cause the SPP device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as virtual machine(s) or virtual server(s) that may be managed in a cloud-based computing environment. Also, the application(s), and even the SPP device 202 itself, may be located in virtual server(s) running in a cloud-based computing environment rather than being tied to one or more specific physical network computing devices. Also, the application(s) may be running in one or more virtual machines (VMs) executing on the SPP device 202. Additionally, in one or more embodiments of this technology, virtual machine(s) running on the SPP device 202 may be managed or supervised by a hypervisor.

In the network environment 200 of FIG. 2, the SPP device 202 is coupled to a plurality of server devices 204(1)-204(n) that hosts a plurality of databases 206(1)-206(n), and to a plurality of client devices 208(1)-208(n) via communication network(s) 210. A communication interface of the SPP device 202, such as the network interface 114 of the computer system 102 of FIG. 1, operatively couples and communicates between the SPP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SPP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SPP devices that efficiently implement a method for providing a dynamic Unified Payment Interface (UPI).

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), Public Switched Telephone Network (PSTNs), Ethernet-based Packet Data Networks (PDNs), combinations thereof, and the like.

The SPP device 202 may be a standalone device or integrated with one or more other devices or apparatuses, such as one or more of the server devices 204(1)-204(n), for example. In one particular example, the SPP device 202 may include or be hosted by one of the server devices 204(1)-204(n), and other arrangements are also possible. Moreover, one or more of the devices of the SPP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the SPP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to receive raw speech data, processed speech data, encoded text into image data, embedded image into diagram data, and/or data associated with machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SPP device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SPP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SPP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SPP device 202, the server devices 204(1)-204(n), or the client devices 208(1)-208(n), for example, may be configured to operate as virtual instances on the same physical machine. In other words, one or more of the SPP device 202, the server devices 204(1)-204(n), or the client devices 208(1)-208(n) may operate on the same physical device rather than as separate devices communicating through the communication network(s) 210. Additionally, there may be more or fewer SPP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, Packet Data Networks (PDNs), the Internet, intranets, and combinations thereof.

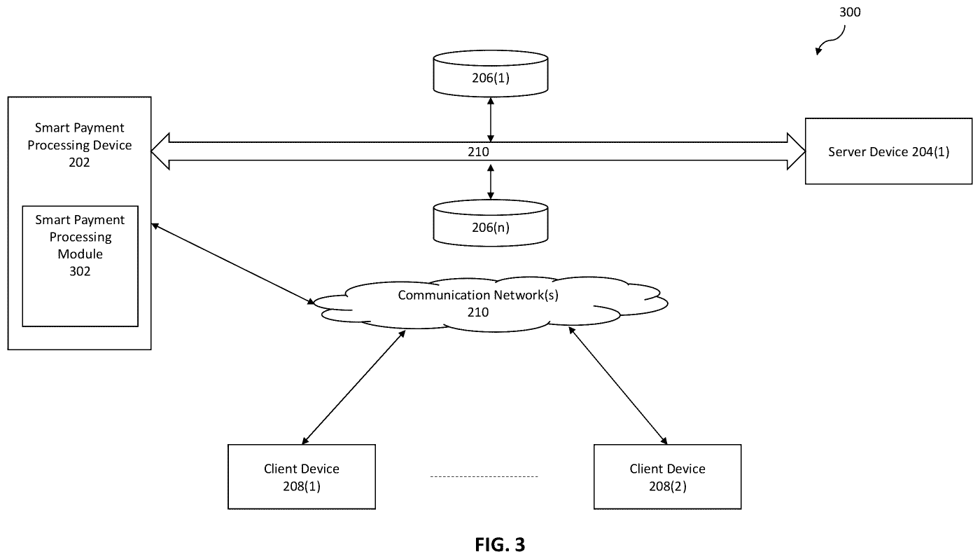

FIG. 3 shows an exemplary system for implementing a method for providing a dynamic Unified Payment Interface (UPI), in accordance with an embodiment of the present disclosure. As illustrated in FIG. 3, according to exemplary embodiments, the system 300 may comprise an SPP device 202 including an SPP module 302 that may be connected to a server device 204(1) and one or more repository 206(1) . . . 206(n) via a communication network 210, but the disclosure is not limited thereto.

The SPP device 202 is described and shown in FIG. 3 as including a Smart Payment Processing module 302, although it may include other rules, policies, modules, databases, or applications, for example. As will be described below, the Smart Payment Processing module 302 is configured to implement a method for providing a dynamic Unified Payment Interface (UPI).

An exemplary process 300 for implementing a mechanism for optimizing and providing the dynamic Unified Payment Interface (UPI) of FIG. 2 is shown as being executed in FIG. 3. Specifically, a first client device 208(1) and a second client device 208(2) are illustrated as being in communication with SPP device 202. In this regard, the first client device 208(1) and the second client device 208(2) may be “clients” of the SPP device 202 and are described herein as such. Nevertheless, it is to be known and understood that the first client device 208(1) and/or the second client device 208(2) need not necessarily be “clients” of the SPP device 202, or any entity described in association therewith herein. Any additional or alternative relationship may exist between either or both of the first client device 208(1) and the second client device 208(2) and the SPP device 202, or no relationship may exist.

Further, SPP device 202 is illustrated as being able to access the one or more repositories 206(1) . . . 206(n). The Smart Payment Processing Module 302 may be configured to access these repositories/databases for implementing a method for providing a dynamic Unified Payment Interface (UPI).

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SPP device 202 via broadband or cellular communication. Of course, these embodiments are merely exemplary and are not limiting or exhaustive.

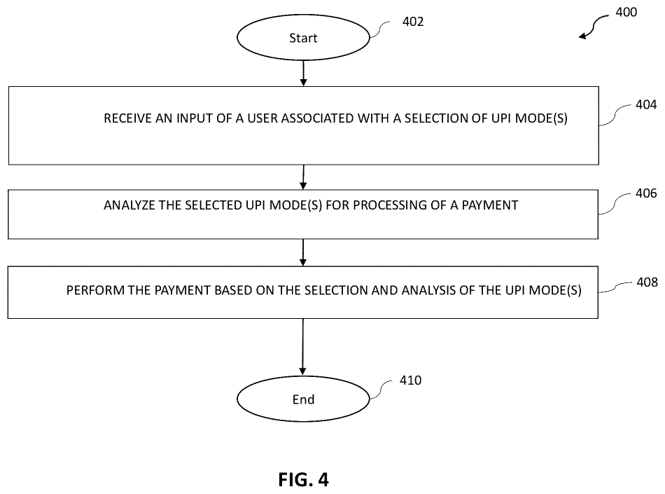

Referring to FIG. 4, an exemplary method is shown for providing a dynamic and optimized Unified Payment Interface (UPI), in accordance with an embodiment of the present disclosure. As shown in FIG. 4, the method begins at step following a need for a dynamic UPI interface to perform quick and reliable payments.

At step [404], the method comprises receiving, at a processor, an input of a user associated with a selection of at least one UPI mode from a plurality of UPI modes. The plurality of modes includes a basic UPI mode, a custom UPI mode and an Artificial Intelligence based mode. At step [406], the method comprises analyzing, by the at least one processor, the UPI mode(s) selected by the user for processing of a payment. At step [408], the method includes performing, by the at least one processor, the payment based on the selection and analysis of the UPI mode(s) selected by the user.

The plurality of UPI modes includes the Basic UPI mode. When the Basic UPI mode is selected, the method may further include the step of receiving, at the processor, an input of the user associated with a selection of at least one default rule from a plurality of default rules: and the step of performing the payment based on the default rule selected by the user. In an example, user X installs the UPI application associated with the present invention on the smartphone for the payment. The user X configured account is associated with bank-1 and bank-2 in the application for the payment. The bank-1 account has a defined limit to be maintained as a minimum balance for any transactions. The user X has made bank-1 account as a default account for performing any transaction of a lesser amount. This condition will be the default set of rules selected by the user X for any UPI payment of a lesser amount.

In an example, the default rule may include but not be limited to “minimum balance rule”, “choose stable account”, “do pending transaction of a defined date” and the like.

The plurality of modes includes the Custom UPI mode. When the Custom UPI mode is selected, the method may further include the step of receiving, at the processor, an input of the user associated with a creation of one or more custom rules that satisfy at least one requirement of the user; and the step of performing, by the processor, the payment based on the custom rule created by the user. The custom UPI mode is a mode that is customizable by the user as per the user requirements. In the custom UPI mode, the user has the flexibility to create rules as per the conditions and requirements. For instance, the user can put a cap on the payment, and the can easily manage credit and debit cards using some custom rules. The customization is done as per user's choice to avoid the run-time issues while doing UPI payment. In an example, a user X, after installing the UPI application and adding all bank details for the transaction, is set for any kind of digital payment. The user X customizes its bank-1 details by putting a rule associated with the restriction of number of transactions to be done from the related bank cards. In an example, the user can define a rule to perform the professional transactions from bank-2 and the domestic transactions from the bank-1 account.

In an example, the user can create new custom rules such as the user can specify that for first 15 days of the month use account A, and for next 15 days use account B for the transactions.

The plurality of modes includes the Artificial Intelligence (AI) based UPI mode. When the AI based UPI mode is selected, the method may further include the step of receiving, at the processor, a set of data associated with payments that have been made by the user in the past. The set of data may include any one or more of the following: user transaction history, bank stability history, user preference mode of transaction, user defined configuration rules, current bank server health, current bank server stability and connectivity, and user preferences with respect to balance availability and the like. Next, when the AI based mode is selected, the method may further include the step of analyzing, by the processor using a trained model, the set of data for a recommendation of at least one optimized payment mode: and the step of recommending, by the processor, at least one optimized payment mode for the processing of the payment.

In an exemplary embodiment, when the AI based UPI mode is selected, the method may further include analysis of the set of data for a recommendation of at least one optimized payment mode using at least one trained model technique. The analysis of the trained model is based on different factors, which may include but are not limited to user preferences, configuration rules, bank server health and connectivity, bank server stability, geographical parameters, transaction history etc. In an example, user X performs a certain number of transactions using the UPI service associated with different bank accounts. The transactions history of the user is saved on the server based on the permission of the user. The present invention, in the AI mode, analyzes all the previous transactions to check the pattern related to the successful transactions, failed transactions, frequent transactions and the like. The analysis of the previous transactions of the user X shows that bank-1 account is extensively used by the user and the transaction time is also less than the time taken in the transaction performed using bank-2. Based on this analysis, the AI based UPI mode recommends the best UPI account out of the multiple UPI accounts for transaction to the user X. The AI based UPI mode also keeps track of the transactions to remind the user about various situations associated with minimum balance, EMI reminder and the like. The AI based UPI mode also provides post recommendation action and post transaction actions for the efficient transactions.

In an example, the AI based UPI mode receives the health status of the UPI account servers and updates it in database accordingly. Next, the present invention fetches the best UPI identifications (IDs) with a user selected mode. Next, the processor is responsible for returning the best UPI account, depending on the selected mode, and it establishes a conversation with an AI module to do its analysis based on the fetched information of the user's transactions. Next, the AI module is responsible for making an appropriate decision by analyzing the previous transaction history and the current stability of the bank in back-ends. Finally, the AI module provides a recommendation to the user for performing transactions without any hindrance or any technical glitches. In an embodiment of the present disclosure, when the Artificial Intelligence based UPI mode is selected, the method further includes recommending, by the processor, one or more actions to be performed based on transactions history of the user. For instance, based on the past transactions, the processor in AI based UPI mode may send one or more reminders to the user to clear due payments before the due date to prevent any delay cost.

In an example, a user X has set a rule for its credit card that after every 15^{th} day of the month, the UPI transaction needs to switch to a credit card of another bank account and the payment of the credit card bills needs to be done automatically one day before the due date from the bank account which has maximum available balance. To execute this, the AI module diverts the transactions of user to other two remaining accounts for casual payments and clears the credit card bills automatically using the best possible way without requiring much intervention of the user. Thus, the present disclosure provides a method and system for optimizing the dynamic Unified Payment Interface (UPI), and the method terminates at step [410].

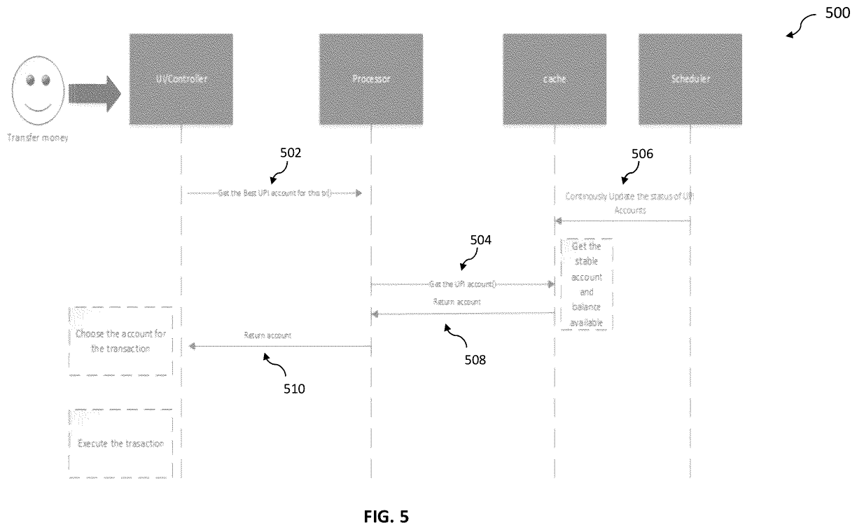

FIG. 5 shows an exemplary sequence diagram 500 for the Basic UPI mode as used in connection with the Unified Payment Interface (UPI), in accordance with an embodiment of the present disclosure. As illustrated in FIG. 5, according to exemplary embodiment 500, the sequence diagram is disclosed for identifying the account for the transaction and execute the same on behalf of the user. Based on the request for the transaction in the Basic UPI Mode, at step 502, the User Interface (UI)/Controller calls the processor to get the best UPI account for the transaction. In an embodiment, the processor comprises a scheduler, cache memory, control unit, and an arithmetic and logic unit (ALU), but is not limited thereto. At step 504, the processor is configured for providing the best UPI account based on the information collected from the cache related to updated stable account with balance for the transactions. At step 506, the information associated with the stable account and the balance availability is updated in the cache memory by the scheduler based on the real-time monitoring of the accounts. In an example, the scheduler continuously updates the status of the UPI accounts in the cache memory and accordingly, the processor determines or chooses the best UPI account for the transaction. Further, the job of the scheduler meanwhile is to continuously update the status of UPI accounts and reflect it into the cache memory. Having the status of the UPI account retrieved from the cache at step 508, the processor will return the UPI account to the UI/Controller at step 510 for executing the transaction as per the user choice. In an embodiment of the present disclosure, the processor may include the Controller and scheduler for enabling the features of the present invention. In another embodiment of the present disclosure, the Controller and scheduler may be located at the appropriate location to enable the features of the present invention.

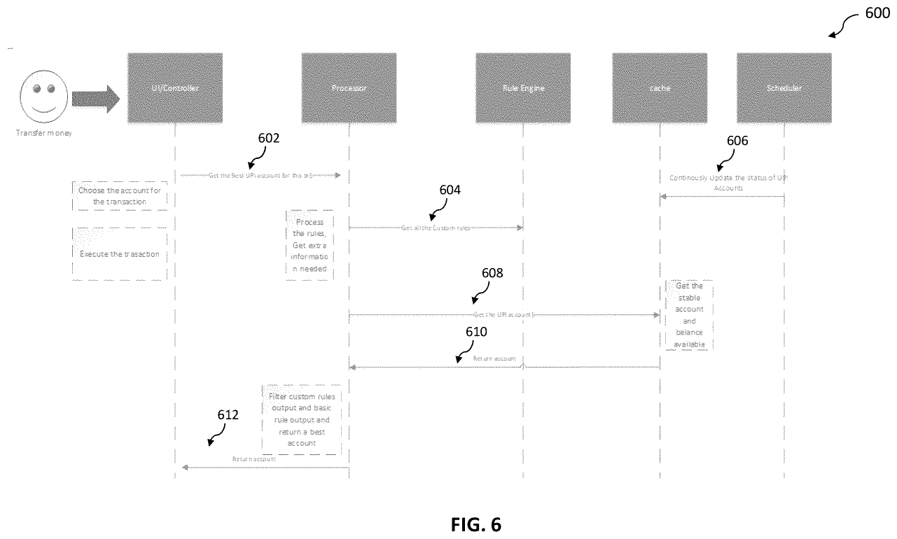

FIG. 6 shows an exemplary sequence diagram 600 for the Custom UPI mode as used in connection with the Unified Payment Interface (UPI), in accordance with an embodiment of the present disclosure. As illustrated in FIG. 6, according to exemplary embodiment 600, the sequence diagram illustrates the mechanism to perform a transaction based on the customized rules by the user. At step 602, the User Interface (UI)/Controller will call the processor to get the best UPI account for the transaction. In an embodiment, the processor comprises a scheduler, rule engine, cache memory, Arithmetic and Logic Unit (ALU), control units and any other unit but is not limited thereto. The processor will process the rules, and also get the extra information such as user defined rules for transaction related to minimum balance, priority of bank account etc. In an example, the scheduler continuously updates the status of the UPI accounts in the cache memory and accordingly, at steps 608 and 610, the processor identifies the best UPI account. Further, the processor fetches the scheduler updates along with the customized rules from the cache memory. In an example, at step 604, customized rules are stored in the rule engine from where the processor will fetch the stored rules by the user. Meanwhile, at step 606, the cache will continuously update the status of UPI accounts from the scheduler. At step 612, the processor will filter the user's custom rules output along with the basic rule output and return a best account to the UI/Controller. The user will finally perform the transaction on the best UPI account returned by the processor to the UI/Controller. The execution of the transaction by the user are based on the customized rules of their own convenience covered by the set of basic rules for UPI transactions.

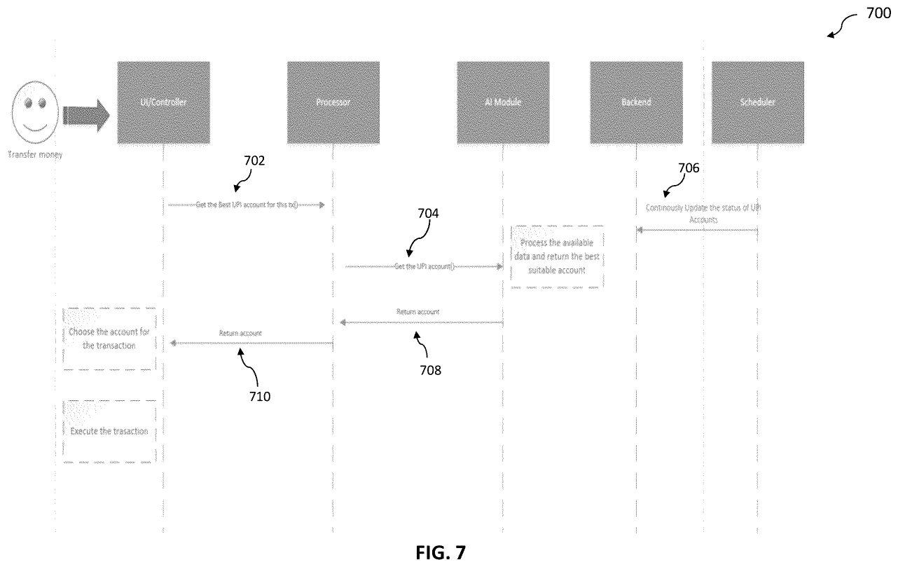

FIG. 7 shows an exemplary sequence diagram 700 for the Artificial (AI) Unified Payment Interface (UPI) mode, in accordance with an embodiment of the present disclosure. As illustrated in FIG. 7, according to exemplary embodiment 700, the sequence diagram illustrates the AI based analysis and processing on the collected data for user's transactions. At step 702, the User Interface (UI)/Controller will call the processor to get the best UPI account for the transaction based on the available account details, and then at step 704, the processor will request the information related to the account and user defined rules analyzed by the AI. The AI analysis involves keeping track of the current stability and history of the user transactions with relation to their bank servers. Keeping track of user's preferences, priorities and configuration rules etc. is a prominent feature for AI to perform deep learning. Further, AI performs deep learning on the transaction history of users and recommends the inputs for consideration to the processor. In an example, deep learning is a subset of specialized AI, a human trained machine language that extracts relevant data for processing and thus, generating the prudent result. The AI will analyze, synthesize or process the available data for returning the best suitable account to the processor. In an embodiment, the processor comprises the scheduler, cache memory, Arithmetic and Logic Unit (ALU), control units and any other unit but is not limited thereto. Furthermore, at the outset, at step 706, the scheduler will continuously update the status of the UPI accounts in a backend of the processor. In an example, the scheduler continuously updates the status of the UPI accounts in the cache memory and accordingly, at steps 708 and 710, the processor identifies the best UPI account and passes it on to the AI for further analysis. The AI mode will function in between the processor and the scheduler that holds the analysis of the user performed transactions in past along with the current bank accounts status or any other transaction associated data not limited thereto. Therefore, in view of above sequence diagrams of the Basic UPI mode, the Custom UPI mode and the AI UPI mode for dynamic Unified Interface Payment (UPI) applications, the present invention provides an efficient and technically advanced solution to the users.

Accordingly, with the technology of the present disclosure, an efficient process for optimizing and providing a dynamic UPI service is disclosed. As evident from the above disclosure, the present solution provides a significant technical advancement over the existing solutions by providing a dynamic UPI platform. It keeps track of the user preferences and configuration rules, bank server health, balance availability, transaction history, geographical parameters, bank server stability and the like which are configured and performed by deep learning on the transaction history of the users. Further, the solution increases efficiency of the user's transactions by keeping track of the current and history stability information of the bank servers and provides its recommendations by considering all the inputs and analysis done for best recommendations to the user. Thus, by providing the plurality of UPI modes such as Basic UPI mode, Custom UPI mode, and AI based UPI mode, the present invention saves time of the user and also efficiently manage the accounts of the user by preventing any delay in pending payment, by keeping limits of the accounts, by choosing the best account for payment, by reminding the users about various negative situations and conditions based on the analysis performed on the above-mentioned factors.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer readable storage medium storing instructions for providing a dynamic Unified Payment Interface (UPI) is disclosed. The instructions include executable code which, when executed by a processor, may cause the processor to receive an input of the user associated with a selection by the user of at least one UPI mode from a plurality of UPI modes: analyze the UPI mode selected by the user for a processing of the payment: and perform a payment based on the selection and analysis of the at least one UPI mode selected by the user. The plurality of UPI modes comprises a Basic UPI mode, a Custom UPI mode and an Artificial Intelligence (AI) based UPI mode.

In accordance with an exemplary embodiment, when the Basic UPI mode is selected, the method further comprises the steps of receiving an input of the user associated with a selection by the user of at least one default rule from a plurality of default rules: and performing the payment based on the default rule(s) selected by the user.

In accordance with an exemplary embodiment, when the Custom UPI mode is selected, the method further comprises the steps of receiving an input of the user associated with a creation by the user of at least one custom rule that satisfies a requirement of the user; and performing the payment based on the custom rule(s) created by the user.

In accordance with an exemplary embodiment, when the Artificial Intelligence (AI) based UPI mode is selected, the method further comprises the steps of receiving a set of data associated with payments that have previously been made by the user: analyzing the set of data using a trained model for a recommendation of at least one optimized payment mode; and recommending the at least one optimized payment mode for the processing of the payment. In accordance with an exemplary embodiment, the set of data may include any one or more of user transaction history, bank stability history, user preference mode of transaction, user defined configuration rules, current bank server health, current bank server stability and connectivity, and user preferences with respect to balance availability and the like. In accordance with an exemplary embodiment, the Artificial Intelligence (AI) UPI mode provides post recommendation actions and post transaction actions.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing a dynamic Unified Payment Interface (UPI) to a user, the method being implemented by a processor, the method comprising:
receiving, at the processor, an input of the user associated with a selection by the user of at least one UPI mode from a plurality of UPI modes;
analyzing, by the processor, the at least one UPI mode selected by the user fora processing of a payment; and
performing, by the processor, the payment based on the selection and analysis of the at least one UPI mode,
wherein the plurality of UPI modes comprises a basic UPI mode, a custom UPI mode and an Artificial Intelligence (AI) based UPI mode.

2. The method as claimed in claim 1, wherein when the basic UPI mode is selected, the method further comprises:
receiving, at the processor, an input of the user associated with a selection by the user of at least one default rule from a plurality of default rules; and
performing, by the processor, the payment based on the default rule selected by the user.

3. The method as claimed in claim 1, wherein when the custom UPI mode is selected, the method further comprises:
receiving, at the processor, an input of the user associated with a creation by the user of at least one custom rule that satisfies a requirement of the user; and
performing, by the processor, the payment based on the at least one custom rule created by the user.

4. The method as claimed in claim 1, wherein when the Artificial Intelligence based UPI mode is selected, the method further comprises:
receiving, at the processor, a set of data associated with payments previously made by the user;
analyzing, by the processor using a trained model, the set of data for a recommendation of at least one optimized payment mode; and
recommending, by the processor, the at least one optimized payment mode for the processing of the payment.

5. The method as claimed in claim 4, wherein the set of data comprises user transaction history, bank stability history, user preference mode of transaction, user defined configuration rules, current bank server health, current bank server stability and connectivity, and user preferences with respect to balance availability.

6. The method as claimed in claim 4, wherein when the Artificial Intelligence based UPI mode is selected, the method further comprises:
recommending, by the processor, at least one action to be performed based on a transactions history of the user.

7. A computing device configured to implement an execution of a method for providing a dynamic Unified Payment Interface (UPI) to a user, the computing device comprising:
a processor;
a memory; and
a communication interface coupled to each of the processor and the memory, wherein the processor is configured to:
receive, via the communication interface, an input of the user associated with a selection by the user of at least one UPI mode from a plurality of UPI modes;
analyze the at least one UPI mode selected by the user for a processing of a payment; and
perform the payment based on the selection and analysis of the at least one UPI mode,
wherein the plurality of UPI modes comprises a basic UPI mode, a custom UPI mode and an Artificial Intelligence based UPI mode.

8. The computing device as claimed in claim 7, wherein when the basic UPI mode is selected, the processor is further configured to:
receive, via the communication interface, an input of the user associated with a selection by the user of at least one default rule from a plurality of default rules; and
perform the payment based on the default rule selected by the user.

9. The computing device as claimed in claim 7, wherein when the custom UPI mode is selected, the processor is further configured to:
receive, via the communication interface, an input of the user associated with a creation by the user of at least one custom rule that satisfies a requirement of the user; and
perform the payment based on the at least one custom rule created by the user.

10. The computing device as claimed in claim 7, wherein when the Artificial Intelligence based UPI mode is selected, the processor is further configured to:
receive, via the communication interface, a set of data associated with payments previously made by the user;
analyze the set of data using a trained model for a recommendation of at least one optimized payment mode; and
recommend the at least one optimized payment mode for the processing of the payment.

11. The computing device as claimed in claim 10, wherein the set of data comprises user user transaction history, bank stability history, user preference mode of transaction, user defined configuration rules, current bank server health, current bank server stability and connectivity, and user preferences with respect to balance availability.

12. The computing device as claimed in claim 10, wherein when the Artificial Intelligence based UPI mode is selected, the processor is further configured to:
recommend at least one action to be performed based on a transactions history of the user.

13. A non-transitory computer readable storage medium storing instructions for providing a dynamic Unified Payment Interface (UPI) to a user, the instructions comprising executable code which, when executed by a processor, causes the processor to:
receive an input of the user associated with a selection by the user of at least one UPI mode from a plurality of UPI modes;
analyze the at least one UPI mode selected by the user for a processing of a payment; and
perform the payment based on the selection and analysis of the at least one UPI mode,
wherein the plurality of UPI modes comprises a basic UPI mode, a custom UPI mode and an Artificial Intelligence based UPI mode.

14. The storage medium as claimed in claim 13, wherein when the basic UPI mode is selected, the executable code further causes the processor to:
receive an input of the user associated with a selection by the user of at least one default rule from a plurality of default rules; and
perform the payment based on the default rule selected by the user.

15. The storage medium as claimed in claim 13, wherein when the custom UPI mode is selected, the executable code further causes the processor to:
receive an input of the user associated with a creation by the user of at least one custom rule that satisfies a requirement of the user; and
perform the payment based on the custom rule created by the user.

16. The storage medium as claimed in claim 13, wherein when the Artificial Intelligence based UPI mode is selected, the executable code further causes the processor to:
receive a set of data associated with payments previously made by the user;
analyze the set of data using a trained model for a recommendation of at least one optimized payment mode; and
recommend the at least one optimized payment mode for the processing of the payment.

17. The storage medium as claimed in claim 16, wherein the set of data comprises user transaction history, bank stability history, user preference mode of transaction, user defined configuration rules, current bank server health, current bank server stability and connectivity, and user preferences with respect to balance availability.

18. The storage medium as claimed in claim 16, wherein when the Artificial Intelligence based UPI mode is selected, the executable code further causes the processor to:
recommend at least one action to be performed based on a transactions history of the user.
